(19) United States
(12) Patent Application Publication
(10) Pub. No.: US 2015/0219038 A1
(43) Pub. Date: Aug. 6, 2015

(54) CYLINDER LINER

(71) Applicants: Paulo José Da Rocha Mordente, Jundiai (BR); Denys Flores, Sao Paulo (BR); Robert R. Banfield, Sao Paulo (BR); José V. Lima Sarabanda, Sao Paulo (BR)

(72) Inventors: Paulo José Da Rocha Mordente, Jundiai (BR); Denys Flores, Sao Paulo (BR); Robert R. Banfield, Sao Paulo (BR); José V. Lima Sarabanda, Sao Paulo (BR)

(21) Appl. No.: 14/431,299

(22) PCT Filed: Sep. 26, 2012
(86) PCT No.: PCT/BR2012/000368

§ 371 Date: Mar. 25, 2015

(51) Int. Cl. F02F 1/00; C22C 38/44; C22C 37/00

(52) U.S. Cl. CPC F02F 1/004; C22C 37/00; C22C 38/44

(57) ABSTRACT

A cylinder liner for an internal combustion engine may include a cylinder. The cylinder may include a first cylindrical portion coupled to a second cylindrical portion. The second portion may be positioned towards a region of combustion in relation to the first portion and define at least in part a combustion chamber. The first portion may include a length at least one half of a length of the cylinder. At least one of the first portion and the second portion may be composed of a ferrous alloy.

### CROSS-REFERENCE TO RELATED APPLICATIONS

This application claims priority to International Patent Application No. PCT/BR2012/000368, filed Sep. 26, 2012, the contents of which are hereby incorporated by reference in their entirety.

### TECHNICAL FIELD

The present invention relates to a component of an internal combustion engine, more specifically to cylinder liners comprising two metal portions integrally associated to one another, the material of each thereof having a different resistance to corrosion such as to render it possible that the region of the cylinder liner most proximate to the combustion chamber may have a superior resistance to corrosion.

### BACKGROUND

Cylinder liners applied in internal combustion engines are engine components which experience significant wear due to the type of work which they perform.

Consonant with the new market demands, the internal components of the new engines are subject to greater demands and, in this sense, are required to offer solutions capable of offering better performance, and also of contributing to the improved reliability and performance of the engine.

Additionally, the entire production chain of the world automotive industry has been challenged by the requirement to reduce the atmospheric emissions generated through the burning of fossil fuels. Although automobiles are already available with hybrid propulsion (automobiles provided with internal combustion engines and electric motors), and vehicles with purely electric propulsion appear to be achievable targets in the short to medium term, such solutions are not applicable to freight and passenger transport vehicles by virtue of the greater power of these engines and the requirement for great autonomy.

Consequently, diverse manufacturers of automotive components seek diverse technical solutions, particularly for, inter alia, cylinder liners of internal combustion engines, applied for example in commercial vehicles. Some of these solutions act directly on the combustion such that the exhaust gases are less harmful to man and to nature. With this objective, an increase in combustion pressures and the utilization of the system of recirculation of gases (hereinafter referred to simply by the abbreviation EGR) have been widely employed, the trend of which in the medium term will be to equip a large proportion of the fleet manufactured.

Although such a strategy has been shown to be effective in the reduction of emissions, the application of EGR has a collateral effect. The recirculation of the gases generates corrosive products which react with the internal walls of the cylinders, damaging them. As the introduction of the corrosive gases from combustion takes place in the combustion chamber, the damaging effects occur more in the portion of the cylinder most proximate to the head. Such reaction considerably diminishes the durability of the system which, in turn, brings about an earlier deterioration in the level of control of the emissions of polluting gases.

Concomitantly with the use of EGR, the aforementioned increase in combustion pressures demands materials having greater mechanical strength, more particularly in the portion of the cylinders most proximate to the head, specifically in the 50% most proximate to the said head.

In summary, the material and the technology employed in the cylinder liners have to bear the existing high pressures, together with the corrosion which occurs in a more accentuated manner in the portion of the cylinders most proximate to the head. It is furthermore noted that in those engines which operate with the diesel cycle, this type of wear is also very accentuated, due particularly to the presence of sulfur in the diesel fuel.

Consequently, the possible solutions permitting improvement in the performance of engines subject to the aforementioned conditions may be achieved by way of an improvement in the quality of the material utilized to produce the cylinder liners, at all times taking into consideration the cost of such solution. In this respect, several advances exist, particularly in those cylinder liners comprising ferrous alloys.

One of the principal alloys applied in the production of cylinder liners in the state of the art is the gray cast iron alloy. Such alloy has a lower cost and, principally, excellent tribological characteristics due to the presence of a large quantity of solid lubricant, in the form of graphite, on the sliding surface. Nevertheless, this material does not offer the corrosion resistance required for the cylinders applied in diesel engines which the current environmental regulations require.

A possible alternative may be found through cylinder liners obtained from steel, for example stainless steel. However, whilst these alloys have greater mechanical strength and resistance to corrosion as a characteristic, the high cost makes the use of this material unviable.

Optionally, coatings may be realized on the working surface of the cylinder liners however, similarly, the high cost prejudices this technical solution.

Whilst the solution to the aforedescribed problem of wear may appear to be simple, because it would be sufficient to replace the component (cylinder liner) by another of more noble material, there are limiting factors to be considered.

In the attempt to resolve the problem a technology has been developed capable of making simultaneous use of two materials in a cylinder liner. In other words, the component has a variable composition along its length.

It is noted that currently the cylinders/cylinder liners applied in internal combustion engines are obtained through the process of centrifugally cast bushes wherein the metal in the liquid state is poured into a rotary mold. Through centrifugal force the final result of the casting process is a bush or tube.

In this manner, through the conventional process it is possible to pour iron alloys having diverse compositions, but it is not possible to obtain tubes or bushes having a variable composition along the length of the bush with a cast part.

The solution passes through a welding stage, however the requirement to weld the two metals presents immense problems, such as the embrittlement of the region where the join of the two materials occurs which would not support the high loads to which a cylinder liner is subject.

It is noted that the conventional welding processes, for example TIG and electric arc, permit the joining of the pairs of metals object of the present invention, however it is known that the energy provided required for the heating must be sufficient to bring about the melting of the materials, a reality which compromises the minimum requirements of quality of the weld for the good performance of the component.

There are various relevant aspects to be considered, given that the cylinder operates with high cyclic loads due to the mechanical loading imparted by the high variable pressures of combustion gases and the steep thermal gradient. Thus, any discontinuity or defect must be prevented in order to ensure the resistance to mechanical and thermal fatigue of the component.

It is consequently necessary to satisfy some relevant aspects in order to obtain a welded region of good quality in cylinder liners, such as:
Integrity of the welded join which must lack surface or subsurface defects, such as fissures or pores due to the melting and subsequent solidification of the materials;
Retention of the mechanical properties of the welded pair. It is known that large provisions of heat lead to the melting of the material, causing the embrittlement of the welded region and of its adjacent parts due to the cooling process. Consequently the zone affected by the heat, by virtue of being a point of embrittlement of the material, must be minimized or even prevented;
Maintenance of the geometry of the cylinder. Following the welding process it is foreseeable that a bimetallic cylinder liner may present non-homogeneous contraction due to the difference in the coefficient of expansion between the materials. It is noted, moreover, that these same reasons lead to the provision of heat not being uniform nor simultaneous along the length of the region to be welded. As a natural consequence the final component will have a geometry which is non-circular in cross-section and non-rectilinear in its longitudinal section, requiring excess metal sufficient for the correction of distortions by means of the removal of material by the process of machining.

Consequently, in order to prevent the negative effects flowing from the provision of heat and subsequent solidification, the present invention makes use of a specific welding process known as friction welding with a non-consumable pin (friction steel welding, FSW) which hereinafter shall be referred to as FSW welding.

In this respect, the document EP 985483 of the prior art reveals the use of FSW welding for welding hollow structures, such as tubes, for structural applications of the lattice or beam types. However, such a solution presents a disadvantage flowing from the requirement that the extremities to be welded possess ribs with the object of supporting the great compressive stress generated by the rotary point which creates friction on the surface to generate the welding of the material.

Furthermore, the Japanese document JP 10180467 also reveals the application of FSW welding technology in the welding of tubes, constituted of non-ferrous metals, with the objective of providing a tube longer than the original. Such tubes have as application the transport of fluids (liquid or gas), the finish of the weld on the internal surface of the tubes not being of any significance, such that there is no mechanical working of removal of material on the inner surface of the tube, which may present burrs or depressions.

Consequently the present invention has not found a solution in the presently known technologies. On the one hand because the resultant products are far from having an application similar to cylinder liners and, on the other, through not dealing with alloys, together with the ratio required between the length of the alloys of the two metal rings which will be welded.

As a consequence, there still does not exist a cylinder liner obtained by the joining of two cylindrical portions constituted by different metals, offering high resistance to wear and to corrosion and a low cost.

### SUMMARY

And, therefore, one object of the present invention is to provide a cylinder liner with two portions of differing properties, one of them having lubricant characteristics and the other high resistance to wear and to corrosion.

And, in addition, one object of the invention is to provide a cylinder liner by way of the welding of two cylindrical metal portions.

The objects of the present invention are achieved by way of the provision of a cylinder liner for application in an internal combustion engine, the liner comprising a first and a second metal cylindrical portion, the second portion being orientated towards the head and defining therewith a combustion chamber, the first portion corresponding to at least half the length of the cylinder liner and the second portion totalizing the length of the cylinder liner, the first portion and second portion being integrally associated to each other, wherein at least one of said portions is composed by a ferrous alloy.

### BRIEF DESCRIPTION OF THE DRAWINGS

The present invention shall be described below in greater detail based on examples of execution represented in the drawings. The figures show:

FIG. 1, a representation of the cylinder liner of the present invention.

FIG. 2, a graph of a potentiodynamic polarization scan of the cast iron and of the steel.

### DETAILED DESCRIPTION

As previously stated, the present invention refers to cylinder liners 1 having different characteristics consonant with the region of the cylinder liner 1.

In view of the new environmental parameters with which assemblers have to comply, the increase in combustion pressures, and the utilization of the system of recirculation of gases, require that the cylinder liners 1 have superior mechanical properties and chemical resistance. The cost of the component being an obstacle, the present invention offers a solution for internal combustion engines, particularly those operating with the diesel cycle.

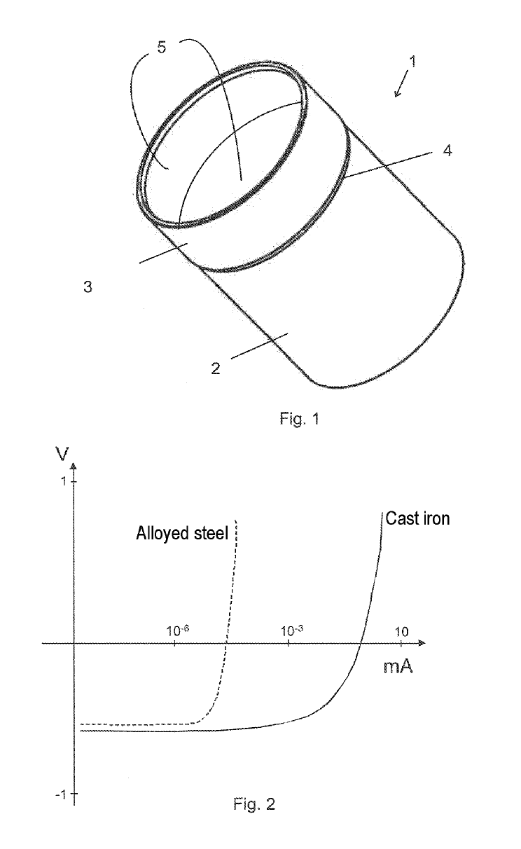

The solution encountered is achieved by the joining of two tubes of different materials and with properties optimized for the performance of the product. Consequently, as shown by FIG. 1, the cylinder liner 1 comprises a first portion 2 and a second portion 3, both being metal and cylindrical.

It is noted that the second portion 3 is orientated towards the head and defines therewith the combustion chamber. As has been seen, this region is that subjected to greater mechanical and chemical stresses. In order to support this additional wear, the second portion 3 must be constituted by a material whose mechanical strength and resistance to wear is greater than that of the first portion 2, that is to say, constituted by a more noble metal. In turn, the first portion 2 must be constituted by a metal of lower cost and, preferably, acting as a solid lubricant.

Both portions 2, 3 must be metal, where at least one thereof must be ferrous. In a preferential manner, however not obligatory, the first portion 2 may be constituted by pearlitic or nodular gray cast iron, and the second portion 3 by steel having alloying elements to improve its mechanical strength and resistance to wear and to corrosion. The said steel may comprise the addition of Cr, Mo, Ni, specifically in the following ranges, 0.5% to 10% Cr, 0.5% to 2% Mo and 0.5% to 8% Ni.

In terms of their geometry, both portions 2, 3 must have the same diameter and thickness. In terms of their length, the first portion 2 may correspond to at least 50% of the total length of the cylinder liner 1, and may attain 85%. Naturally, the second portion 3 will have the complementary length to that of portion 2 in order to form the totality of the length of the cylinder liner 1.

In a preferential configuration, but not obligatory, the cylinder liner 1 of the present invention comprises a first portion 2 whose length is 70% and a second portion 3 whose length is 30% of the total length of the cylinder liner 1. In this manner, the 30% corresponding to the portion of the cylinder liner 1 most proximate to the head, being that which is most stressed and which suffers more corrosion, is provided from a more noble and more hard wearing material. Furthermore, the remaining 70% referring to the first portion 2 is constituted by a cheaper material containing graphite, by virtue of the lubricant properties thereof, promoting a low frictional relationship with the other components of the engine. In this manner a product is achieved with optimized properties and of low cost.

In respect of the welding of the first and second portions 2, 3, it is noted that the presence of graphite in the cast iron renders the welding process non-trivial.

Consequently, in order to realize the construction of the cylinder liners 1 of the present invention a process of friction welding has been used. As examples of friction welding there may be considered welding with a non-consumable pin (friction steel welding, FSW) or furthermore other welding processes, by friction, capable of joining different materials and ensuring suitable properties in the welded region. FSW is a welding process already known in other different applications, however its application to the present invention requires special characteristics.

On the one hand, different metal elements require to be welded the affinity whereof may not be so easily reconciled and, on the other hand, optimum working conditions must be ensured in the sliding portion 5 where the piston and its respective segments will move, by virtue of the fact that the finish of the internal region of the weld has a great influence on the performance of the component.

With this objective the two cylindrical metal portions 2, 3 will be welded by friction and will receive a subsequent treatment on the sliding portion 5.

By virtue of the fact that the ratio between the length and diameter of the cylinder liners 1 of the present invention is much lower than those elements obtained through the technology revealed by the document JP 10180467, it is noted that it is possible to access the sliding portion 5 to provide a finish by means of a machining process. In a preferential manner, but not obligatory, the machining process will remove 1 mm to 2 mm, followed by a polishing stage which may be carried out prior to or subsequent to the installation of the cylinder liner 1 in an engine.

It is further noted that in the welding region 4 a refinement of the grain occurs which will ensure the required mechanical strength of the component.

Consequently, rather than having a monolithic cylinder liner where the mechanical and chemical properties would be the same throughout the component, there is obtained a cylinder liner 1 which brings together the best of each material with the objective of providing an optimized cylinder liner at reduced cost.

Proving this assertion, FIG. 2 shows a potentiodynamic polarization scan of the cast iron and of the steel. Knowing that the lower the current measured the lower the corrosive activity of the system, it may be observed that the steel will experience less corrosion than the cast iron. Consequently, the application of the steel in the second portion will result in an increase in the working life of the cylinder liner.

Similarly, consonant with the metal alloys selected for the first portion 2 and the second portion 3 of the cylinder liner 1, a bringing together of different properties distributed selectively in a single component will be achieved.

Examples of preferred embodiments having been described, it shall be understood that the scope of the present invention includes other possible variations, being limited solely by the content of the attached claims, the possible equivalents being included therein.

1. A cylinder liner for an internal combustion engine, comprising: a cylinder including a first cylindrical portion coupled to a second cylindrical portion, the second portion positioned towards a region of combustion in relation to the first portion and defining at least in part a combustion chamber, the first portion including a length at least one half of a length of the cylinder, wherein at least one of the first portions and the second portion is composed of a ferrous alloy.

2. The cylinder liner as claimed in claim 1, wherein the second portion is coupled to the first portion via a friction welded connection.

3. The cylinder liner as claimed in claim 1, wherein the second portion is composed of a material having at least one of a greater mechanical strength, a greater resistance to wear and a greater resistance to corrosion than a material of the first portion.

4. The cylinder liner as claimed in claim 3, wherein the first portion and the second portion define an internal surface having a surface finish via polishing.

5. The cylinder liner as claimed in claim 4, wherein the surface finish via polishing is provided on the internal surface at least one of prior to and subsequent to installing the cylinder liner in an engine.

6. The cylinder liner as claimed in claim 1, wherein the cylinder is configured for an engine having a diesel cycle.

7. The cylinder liner as claimed in claim 1, wherein the length of the first portion corresponds to a value of between 50% and 80% of the length of the cylinder.

8. The cylinder liner as claimed in claim 7, wherein the length of the first portion corresponds to 70% of the length of the cylinder.

9. The cylinder liner as claimed in claim 1, wherein the first portion is composed of a gray cast iron material and the second portion is composed of a steel material, the steel material including at least one alloying element configured to improve at least one of a resistance to corrosion and and a mechanical strength of the second portion.

10. The cylinder liner as claimed in claim 1, wherein the first portion is composed of at least one of a pearlitic gray cast iron material and a nodular gray cast iron material, and the second portion is composed of a steel material having an alloying element including at least one of Cr, Mo and Ni.

11. The cylinder liner as claimed in claim 10, wherein the composition of the second portion includes from 0.5% to 10% Cr, 0.5% to 2% Mo and 0.5% to 8% Ni.

12. The cylinder liner as claimed in claim 2, wherein the second portion is composed of a material having at least one of a greater mechanical strength, a greater resistance to wear and a greater resistance to corrosion than a material of the first portion.

13. The cylinder liner as claimed in claim 12, wherein the length of the first portion corresponds to a value between 50 percent and 80 percent of the length of the cylinder.

14. The cylinder liner as claimed in claim 3, wherein the first portion is composed of a gray cast iron material and the second portion is composed of a steel material, wherein the steel material of the second portion includes at least one alloying element configured to improve at least one of the resistance to corrosion and the mechanical strength of the second portion.

15. The cylinder liner as claimed in claim 14, wherein the gray cast iron material is at least one of pearlitic gray cast iron and nodular gray cast iron, wherein the at least one alloying element of the steel material includes at least one of Cr, Mo and Ni.

16. The cylinder liner as claimed in claim 14, wherein the steel material includes a concentration of Cr from 0.5% to 10%, Mo from 0.5% to 2% and Ni from 0.5% to 8%.

17. The cylinder liner as claimed in claim 3, wherein the length of the first portion corresponds to a value between 50 percent and 80 percent of the length of cylinder.

18. The cylinder liner as claimed in claim 4, wherein the first portion is composed of a gray cast iron material and the second portion is composed of a steel material, wherein the steel material of the second portion includes at least one alloying element configured to improve at least one of the resistance to corrosion and the mechanical strength of the second portion.

19. The cylinder liner as claimed in claim 4, wherein the length of the first portion corresponds to a value between 50 percent and 80 percent of the length of cylinder.

20. A cylinder liner for an internal combustion engine, comprising:
a cylinder having a length defined by at least a first cylindrical portion composed of a gray cast iron material coupled to a second cylindrical portion composed of a steel material, wherein the second portion is positioned towards a region of combustion in relation to the first portion;
the first portion including a length at least one half of the length defined by the cylinder;
wherein the steel material of the second portion includes at least one alloying element, the at least one alloying element including at least one of Cr, Mo and Ni, wherein the second portion has at least one of a greater mechanical strength, a greater resistance to wear and a greater resistant to corrosion than the first portion.
